(19) United States
(12) Patent Application Publication
(10) Pub. No.: US 2005/0211845 A1
(43) Pub. Date: Sep. 29, 2005

(54) Airship having a multiple-lobed hull

(75) Inventors: William D. Perry, Helotes, TX (US); Thomas M. Lew, San Antonio, TX (US)

Correspondence Address: OLIFF & BERRIDGE, PLC, P.O. BOX 19928, ALEXANDRIA, VA, 22320, US

(73) Assignee: Southwest Research Institute, San Antonio, TX (US)

(21) Appl. No.: 10/944,905

(22) Filed: Sep. 21, 2004

Related U.S. Application Data
(63) Continuation-in-part of application No. 09/633,921, filed on Aug. 8, 2000, now abandoned.

(51) Int. Cl. B64B 1/02

(52) U.S. Cl. 244/125

(57) ABSTRACT

A non-rigid or semi-rigid airship has a hull with a plurality of lobes formed therein. The lobes decrease the radius of curvature of the hull, thereby reducing the stress on the hull due to the pressurized lifting gas contained therein. The reduced stress allows the hull to be constructed from a lighter weight material, thus reducing the mass of the hull, and enabling the airship to carry more cargo. Flexible membranes are used to partially delineate lobes. The membranes are attached to the inner surface of the hull and a group of load lines connected to and running between the membranes form a polygon-shaped cross-sectional area.

### CROSS-REFERENCE TO RELATED APPLICATION

This application is a continuation-in-part application of commonly assigned co-pending parent U.S. patent application Ser. No. 09/633,921 filed Aug. 8, 2000. The subject matter of this parent application is incorporated herein by reference in its entirety.

### BACKGROUND OF THE INVENTION

1. Field of Invention

The present invention relates to the field of lighter-than-air crafts.

2. Description of Related Art

Airships generate buoyant lift by displacing the surrounding air with a hull containing a lighter-than-air gas. Generally, there are three types of airships: rigid, semi-rigid, and non-rigid. The first type uses a hull having a rigid internal framework supported by multiple gas cells. Similarly, the hull of a semi-rigid airship typically has a stiff internal lower keel for supporting a gondola underneath. A non-rigid airship, on the other hand, has no rigid internal framework to support the hull. This type of airship maintains its hull shape with pressure exerted by the pressurized lifting gas contained within the hull.

An illustration of a typical non-rigid airship is shown in FIG. 1. The cigar-shaped airship 10 has a cylindrical hull 12 defining a volume of space wherein a lifting gas (not shown) is held. The lighter-than-air gas generates buoyant lift for the airship 10, thereby allowing the airship 10 to rise and remain suspended in the air. Generally, the larger the volume of lifting gas contained in the hull 12, the greater the amount of lift generated.

Pressurization of the gas provides a stiff hull shape which streamlines the hull and displaces the surrounding air. The outward pressure exerted on the hull creates a certain amount of physical or mechanical stress thereon, which requires the hull skin to be made of a material that is sufficiently strong to be able to withstand the stress. As a consequence of using the sturdier, heavier weight material, the mass of the hull alone may take up a large percentage of the airship's lift capacity, leaving a relatively small fraction of the lift capacity for carrying useful payloads. Accordingly, it is desirable to be able to decrease the amount of stress on the hull of the airship to allow lighter weight hull materials to be used, thereby reducing the hull mass and freeing a larger portion of the airship's lifting capacity for carrying useful payloads. Further, none of the aforementioned airships have a configuration such that clearance is provided down the length of the airship to allow for necessary equipment or objects to be stationed therein.

### SUMMARY OF THE INVENTION

The present invention is directed to an airship wherein the physical stress on the hull has been reduced, thereby allowing the hull to be made of a lighter weight material. Using a lighter weight material results in a reduction of the hull mass, thus leaving a higher percentage of the airship's lift capacity for carrying useful payload. The present invention is further directed to a load line configuration that allows clearance down the length of the airship.

In general, in one aspect, the invention is related to a lighter-than-air vehicle, such as, for example, an airship, comprising a non-rigid cylindrical hull, a pressurized gas contained in the hull, and a plurality of longitudinally extending lobes formed in the hull. Other features of the airship may include a flexible member such as a wall or a mesh attached to essentially opposing sides of the inner surface of the hull and extending along a longitudinal axis of the hull. Still other features may include a flexible curtain attached to an inner surface of the hull and extending along the longitudinal axis of the hull. The flexible curtain may have a suspension line attached to an unbounded portion thereof and a load line attached to the suspension line.

In general, in another aspect, the invention includes means for forming a plurality of longitudinally extending lobes in the hull of a non-rigid hull airship. The means for forming a plurality of longitudinally extending lobes may include a wall or perhaps a mesh attached to essentially opposing sides of the inner surface of the hull and extending along a longitudinal direction of the hull. The means may also include a curtain attached to an inner surface of the hull and extending along the longitudinal direction of the hull. The curtain may have a suspension line attached to an unbounded portion thereof and a load line attached to the suspension line.

In general, in yet another aspect, the invention is related to a method of reducing the amount of physical stress on the hull of a non-rigid airship. The method comprises the steps of inflating the hull by filling the hull with a pressurized gas, and decreasing a radius of curvature of the hull by forming a plurality of longitudinally extending lobes in the hull. Decreasing of the radius of curvature and cross-sectional area of the hull may include drawing in essentially opposing sides of the hull along a longitudinal circumference of the hull.

In general, in yet another aspect, the invention is related to an airship, comprising a non-rigid cylindrical hull, a pressurized gas contained in the hull, a curtain attached to an inner surface of the hull and tracing a longitudinal path around the inner surface of the hull, a suspension line attached to an unbounded edge of the curtain, and a plurality of load lines connecting predefined points along the suspension line, wherein the curtain, suspension line, and load lines function to draw in opposing sides of the hull along the longitudinal axis of the hull and thereby form a plurality of lobes in the hull, each lobe having a decreased radius of curvature for reducing the physical stress on the hull.

In general, in yet another aspect, the invention is related to an airship, comprising a non-rigid cylindrical hull, a pressurized gas contained in the hull, a curtain attached to an inner surface of the hull and tracing a longitudinal path around the inner surface of the hull, a suspension line attached to an unbounded edge of the curtain, and a plurality of fixed length, relatively non-extendible load lines connecting predefined points along the suspension line, wherein the curtain, suspension line, and load lines function to draw in opposing sides of the hull along the longitudinal axis of the hull as the airship is inflated and thereby form a plurality of lobes in the hull, each lobe having a decreased radius of curvature for reducing the physical stress on the hull.

Although introducing lobes into the hull will reduce cross-sectional hoop stress in an embodiment of the present invention, the present invention is also directed to a reduction of stress in the longitudinal direction of the hull. By reducing the stress in the longitudinal direction of the hull, a further mass reduction of the airship is available. This allows for a reduction in volume and a reduction in drag. Size and mass reduction thus allow for improved performance and cost savings.

### BRIEF DESCRIPTION OF THE DRAWINGS

FIG. 1A illustrates a prior art airship;

FIG. 1B is a cross-sectional view of the airship of FIG. 1A;

FIG. 2 illustrates a multiple-lobed airship of the present invention;

FIGS. 3A-3B are cross-sectional views of one embodiment of the multiple-lobed airship shown in FIG. 2;

FIGS. 4A-4B are a cross-sectional view and a cut-away view, respectively, of another embodiment of the multiple-lobed airship shown in FIG. 2;

FIG. 5 is a free body diagram of the forces acting on the hull of the multiple-lobed airship shown in FIG. 2;

FIG. 6 illustrates another multiple-lobed airship of the present invention;

FIG. 7 is a cross-sectional view of one embodiment of the multiple-lobed airship of FIG. 6;

FIG. 8 is a cross-sectional view of another embodiment of the multiple-lobed airship of FIG. 6;

FIG. 9 is a cross-sectional view of yet another embodiment of the multiple-lobed airship of FIG. 6;

FIG. 10 is a cross-sectional view of one embodiment of an airship with a three-lobed hull;

FIG. 11 is a cross-sectional view of another embodiment of an airship with a three-lobed hull;

FIG. 12A is a cross-sectional view of one embodiment of an airship with a six-lobed hull;

FIG. 12B is a cross-sectional view of another embodiment of an airship with a six-lobed hull; and

FIG. 13 is a side view cross-section of an airship with a multi-lobed hull.

### DETAILED DESCRIPTION OF PREFERRED EMBODIMENTS

The invention provides an airship having a plurality of lobes formed in a non-rigid hull. The lobes formed in the hull result in a decrease in the radius of curvature of the hull, resulting in a smaller amount of physical stress being exerted on the hull from pressurized gas. The configuration of the lobes allow for clearance provided down the length of the airship.

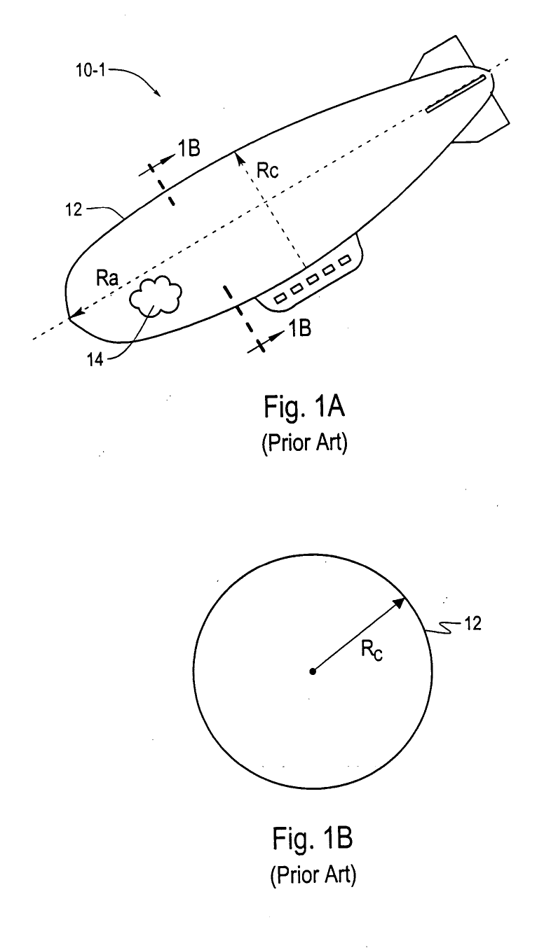

FIGS. 1A and 1B show a typical non-rigid airship. The cigar-shaped airship 10-1 has a cylindrical hull 12 defining a volume of space wherein a lifting gas (not shown) is held. The lighter-than-air lifting gas generates buoyant lift for the airship 10-1, thereby allowing airship 10-1 to rise and remain suspended in the air.

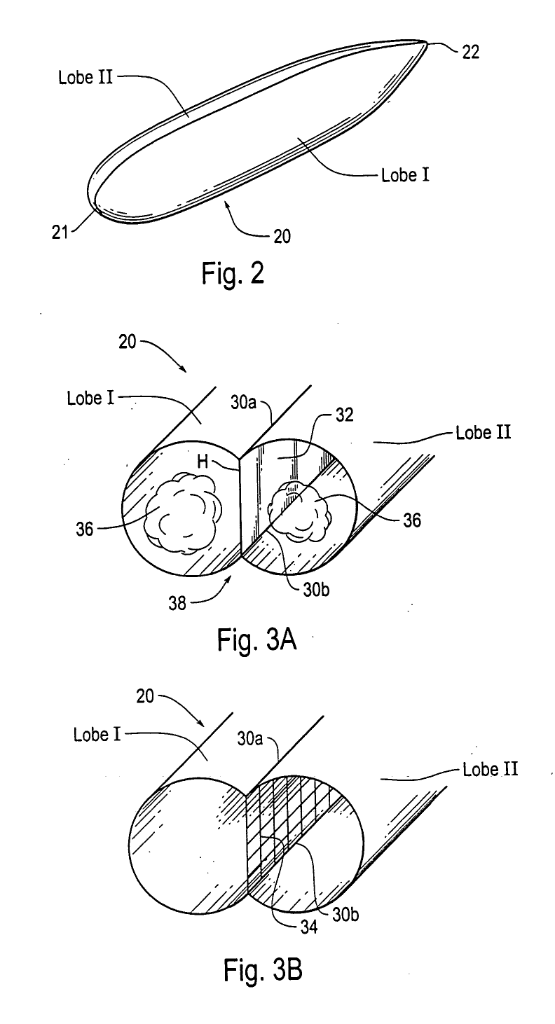

FIG. 2 shows an airship 10-2 with a hull 20 which, according to one embodiment of the present invention, has two lobes: Lobe I and Lobe II. The lobes define a volume of space in which a pressurized lifting gas (not shown) may be contained. Because the gas is distributed in two lobes instead of one, each individual lobe necessarily has a smaller circumferential radius of curvature compared to a hull of equal volume (hence, equal total lifting capacity), but having only a single lobe. The smaller radius of curvature of the lobes means there is less stress acting at any given point on the hull 20 due to pressure exerted by the gas relative to a single-lobed hull. Consequently, a lighter weight hull material may be used to construct the multiple-lobed hull 20.

Examples of the types of materials which may be used to construct the hull 20 include polyethylene, polyester (e.g., MYLAR®), nylon (a polyamide), polyurethane, various woven fabrics, aramids, and synthetic fabrics sold under the brand names of KEVLAR®, an aramid fiber and SPECTRA®, an ultra-high molecular weight polyethylene fiber.

Referring to FIGS. 3A and 3B, longitudinally extending boundaries 30a and 30b trace the intersection between Lobes I and II. The lobes themselves are formed by drawing in the opposing sides (top 37 and bottom 38 in this embodiment) of the hull 20 along the lobe boundaries 30a and 30b. In one embodiment, a flexible membrane such as solid, continuous flexible wall 32 is attached to the inner surface of the hull 20 along the lobe boundaries 30a and 30b. The size and shape of the flexible wall 32 may vary and depends in part on whether the wall 32 is attached to only a certain section of the hull, such as the middle, cylindrical portion, or along the entire longitudinal direction of the hull 20, including the nose 21 and tail 22 portions (See FIG. 2) of the hull 20. The flexible wall 32 may be made of the same material as the hull 20, or it may be made of other suitable materials, such as a gas-permeable material. Attachment of the flexible wall 32 to the hull 20 may be effected by, for example, adhesives or by some other suitable means known to one of ordinary skill in the art.

In operation, when a pressurized lifting gas 36 fills the hull 20, the wall 32 acts as a retainer to keep the essentially opposing sides of the inner surface of the hull 20 along the lobe boundaries 30a and 30b from inflating past the height ‘H’ of the wall 32. The effect of this arrangement is to draw in the opposing sides of the hull 20 along the lobe boundaries 30a and 30b while the rest of the hull 20 is allowed to expand beyond the height ‘H’ of the wall 32, thereby forming Lobes I and II.

In another embodiment, a flexible mesh 34 is used instead of a solid wall. Like the flexible wall 32, the flexible mesh 34 is attached to the hull 20 along the lobe boundaries 30a and 30b (by adhesives or other suitable means) and serves to draw in the opposing sides of the hull 20 to form the lobes. However, an advantage of this embodiment is the mesh 34 generally has less mass than a solid, continuous wall and, therefore, weighs less than the wall. Thus, the mass of the hull 20 may be further reduced by using the mesh 34.

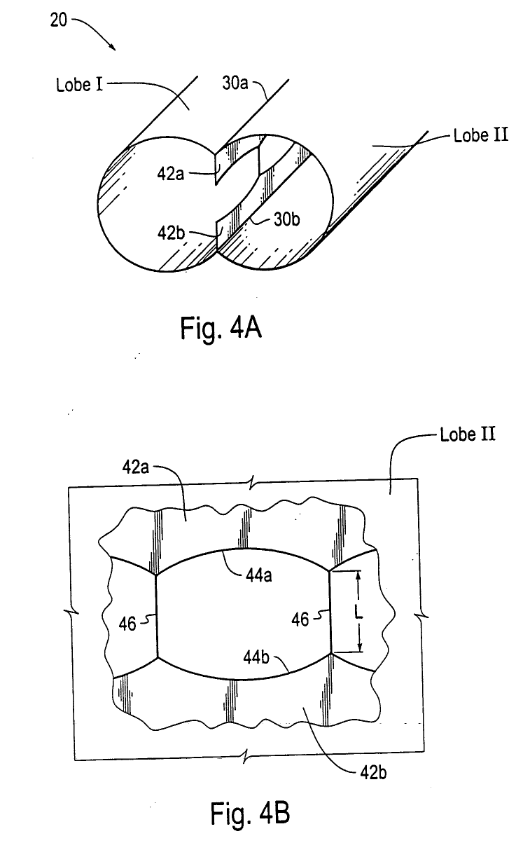

In yet another embodiment, one or more flexible curtains may be used to draw in the sides of the hull 20. Referring now to FIGS. 4A and 4B, flexible curtains 42a and 42b are attached to the hull 20 along the lobe boundaries 30a and 30b, respectively. The flexible curtains 42a and 42b may be attached to the hull 20 by any suitable means and may be made of the same material as the hull 20, or any other material suitable for the purpose. Suspension lines 44a and 44b are attached to the curtains 42a and 42b, respectively, along the unbounded (unattached) edges of the curtains 42a and 42b. One or more load lines 46 connect the suspension lines 44a and 44b to each other at one or more predefined points along the suspension lines. The suspension lines 44a and 44b operate to transfer the load on the curtains 42a and 42b to the load lines 46 to draw in the sides of the hull 20.

The overall structure and shape of the curtains 42a and 42b as depicted in FIGS. 4A and 4B are designed to provide a distributed load which will produce a desired lobed airship hull shape. One advantage of a curtain over a continuous wall is a weight savings.

The flexible curtains 42a and 42b, in addition to weighing less than a wall, also have an advantage in that the height thereof may be easily adjusted by increasing or decreasing the length ‘L’ of the load lines 46. Moreover, if load lines are used with a continuous flexible wall, the height of the continuous flexible wall may also be easily adjusted by increasing the length ‘L’ of the load lines, which may be attached to the lobe boundary portions of one or more of the continuous flexible walls. Furthermore, although two flexible curtains 42a and 42b are shown in this embodiment, other embodiments may have only a single curtain which extends the entire longitudinal direction of the hull 20 along the first one of the lobe boundaries 30a and 30b. Still other embodiments may have multiple curtains, each curtain attached to a predefined section of the hull 20.

Just as the shape of a suspension bridge cable is designed to support a distributed load, the shape of the airship internal curtain is designed to produce the distributed load necessary to create the desired lobing in the hull. While the illustration shown in FIGS. 4A and 4B does resemble the parabolic shape of a suspension bridge cable, this should not imply that a parabolic shape to the suspension cable is the only means to produce the desired hull lobing.

The suspension line parabolic shape is produced when the distributed load has no horizontal force component. For streamlined airships, the distributed load will include a horizontal (axial) force component in addition to the vertical (radial) force component, which will affect the shape of the suspension cable, although it is expected that the suspension cable will still have a scalloped appearance.

Such curtain shapes could be engineered into the original curtain design and subsequently produced by cutting, assembling and fabricating it into the desired shape, or the curtain material itself could be flexible enough to stretch and realign itself after the introduction of the hull forces to produce the desired shape.

More complex suspension cable/curtain shapes could be used as long as the shapes result in a reduction of hull stresses through the introduction of hull lobing. As an example, there are suspension bridges which have straight cables connecting each section of the roadway directly to the bridge towers, called cable-stayed-bridges.

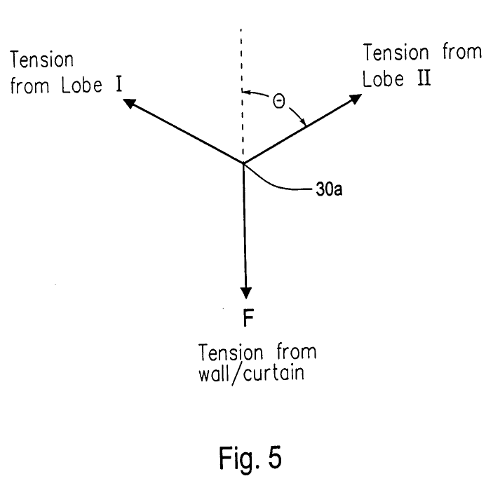

It should be apparent from the above description that some force is required to draw in the opposing sides of the hull. Referring to FIG. 5, the forces acting on the hull at any point along the lobe boundaries, for example the lobe boundary 30a, may be defined generally by the following equation:
F_{wall}=2·σ_{c}·th·cos(θ) (3)
where F_{wall} is the load on the retaining membrane (wall, mesh, or curtain), σ_{c}·th is the circumferential loading on the hull, and θ is the angle between each lobe and a normal axis. Thus, the load F_{wall} on the retaining membrane will depend on the angle θ between the lobes and the normal axis. The angle θ, in turn, may be adjusted by increasing or decreasing the height of the retaining membrane.

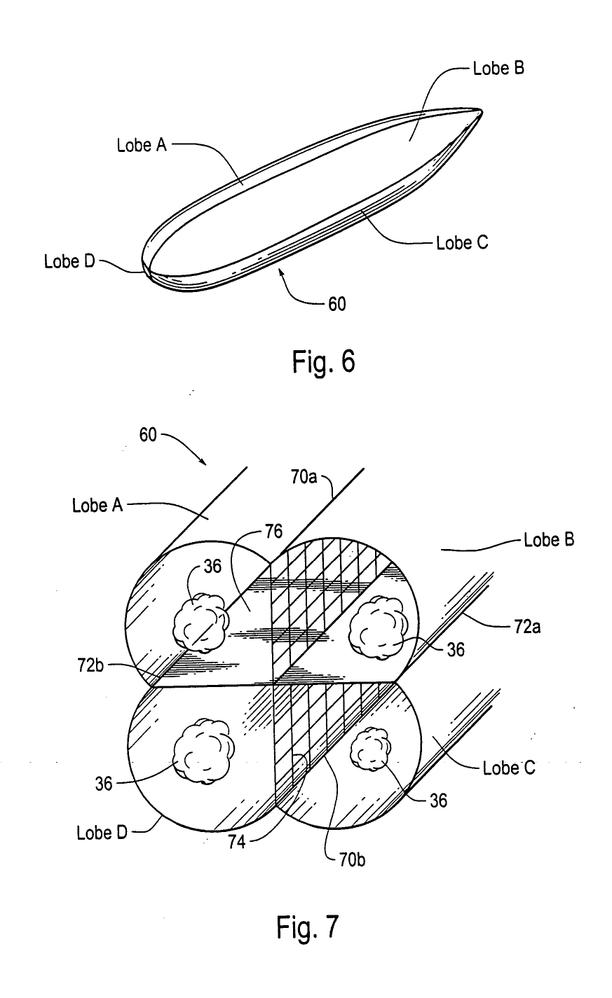

Although only a two-lobed airship has been described thus far, the invention is not to be so limited, and airships having more than two lobes are certainly contemplated to be within the scope of the invention. Referring to FIG. 6, an airship hull 60 has a plurality of lobes: Lobes A, B, C, and D. The lobes define a volume of space within which a pressurized lifting gas is contained. Because the gas is distributed in four lobes, each individual lobe necessarily has a smaller radius of curvature than a hull of equal volume, but having fewer or only a single lobe. More importantly, each of the lobes A, B, C, and D has a comparatively smaller amount of stress acting thereon (due to the pressure of the lifting gas) by virtue of the principles discussed with respect to Equations (1) and (2) above.

In one embodiment, referring to FIG. 7, the four lobes A, B, C, and D are formed by flexible retaining membranes such as a vertical mesh 74 attached to the hull 60 along the top and bottom lobe boundaries 70a and 70b and a horizontal wall 76 similarly attached along the right and left lobe boundaries 72a and 72b. The mesh 74 and wall 76 are shown in the same embodiment here, in part, for economy of the description and drawings and it should be readily evident that walls only or mesh only may be used in other embodiments. A lifting gas 36 fills the lobes A, B, C, and D.

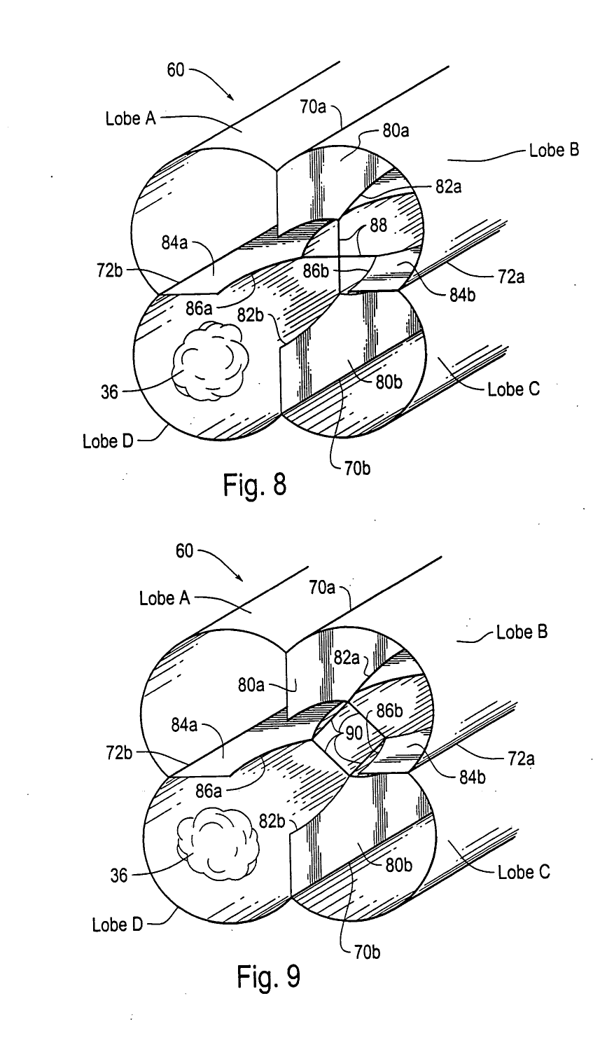

In an alternative embodiment, the lobes are formed by an arrangement of flexible curtains, suspension lines, and load lines, as shown in FIG. 8. Vertical flexible curtains 80a and 80b are attached to the hull 60 along the top and bottom lobe boundaries 70a and 70b. Top and bottom suspension lines 82a and 82b are attached to the free edges of the vertical curtains 80a and 80b, respectively, as shown. Horizontal flexible curtains 84a and 84b are attached to the hull 60 along the right and left lobe boundaries 72a and 72b while right and left suspension lines 86a and 86b are attached to horizontal curtains 84a and 84b, respectively. A plurality of load lines 88 connect the top and bottom suspension lines 82a and 82b to each other at one or more predefined points along the suspension lines 82a and 82b. Similar connections are implemented for the right and left suspension lines 86a and 86b. Again, lifting gas 36 fills the lobes A, B, C, and D.

The retaining membranes, that is, the wall, mesh, and/or the curtain of the four-lobed hull 60 generally operate in much the same way as the retaining membrane of the two-lobed hull 20 and provide similar advantages. However, an additional advantage of using curtains, as opposed to the wall or mesh, is the ease with which the load lines may be routed in between and around each other.

For example, referring to FIG. 9, instead of the load lines linking flexible curtains located on essentially opposing sides of the hull, curtains that are neighboring or adjacent to each other may be linked together. The embodiment shown in FIG. 9 is virtually identical to the embodiment of FIG. 8 except that a plurality of load lines 90 connect predefined points along the suspension lines of neighboring or adjacent curtains. Specifically, the load lines 90 link (via the suspension lines) the top flexible curtain 80a to the left and right curtains 84a and 84b, and also the bottom curtain 80b to the same left and right curtains 84a and 84b. This arrangement of the load lines 90, although routed differently from that of FIG. 8, is functionally equivalent to the load lines 88 in FIG. 8 in terms of drawing in the opposing sides of the hull 60.

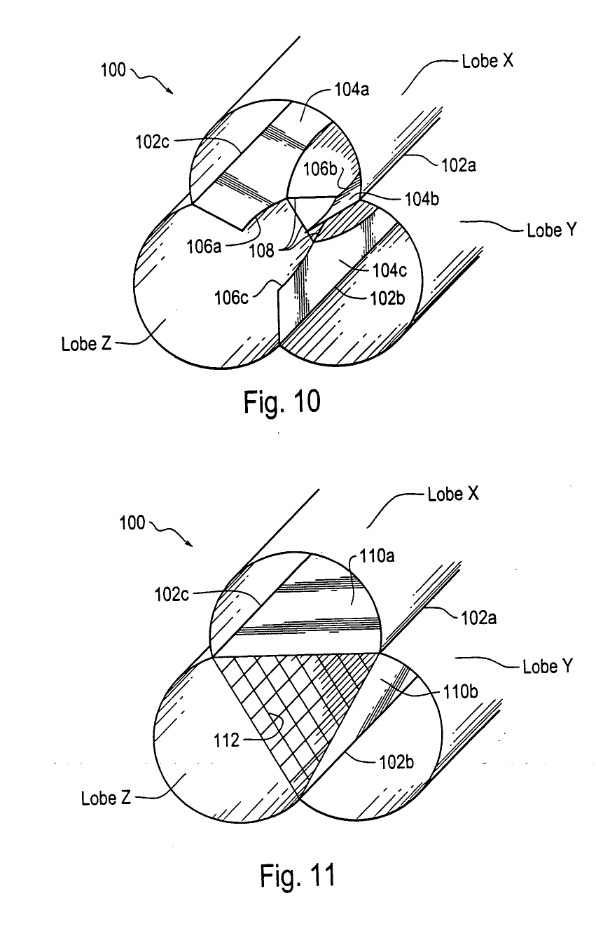

Additionally, one or more lobes may be added or removed from a hull by adding or removing one or more curtains. For example, referring to FIG. 10, by removing one of the curtains, a multiple-lobed hull 100 may have three lobes formed therein: Lobes X, Y and Z, which define lobe boundaries 102a, 102b, and 102c, respectively, and to which are attached a plurality of flexible curtains 104a, 104b, and 104c. Suspension lines 106a, 106b, and 106c are attached to the unattached edges of the curtains 104a, 104b, and 104c, respectively. A plurality of load lines 108 that are connected at predefined points along the suspension lines 106a, 106b, and 106c link adjacent or neighboring curtains together. Specifically, the load lines 108 link (via the suspension lines) the left curtain 104a to both the right curtain 104b and the bottom curtain 104c, which curtains are in turn linked to each other. Thus, by removing curtains, or alternatively, by adding curtains, airship hulls having varying numbers of lobes may be created.

Load lines 108 may be extendible or non-extendible in length. In various exemplary embodiments of the invention, the load lines may be fixed in length so that when the airship is inflated, the load lines 108 remain of fixed length and lobes are formed in the hull as the airship is inflated.

The three-lobed hull 100 of FIG. 10 may also be implemented using walls, mesh, or a combination of both, as depicted in FIG. 11. In this embodiment, the flexible curtains have been replaced with 110a and 110b and a flexible mesh 112. However, rather than being connected to each other at their unattached edges, the walls 110a and 110b and the mesh 112 are attached only to the hull 100 along the lobe boundaries 100a, 100b, and 100c. Under this arrangement, each of the walls 110a and 110b and the mesh 112 causes a separate lobe X, Y, or Z to be formed in the hull 100.

The polygonal load line arrangement allows for a unique configuration in that additional storage space for equipment, or the like, is created.

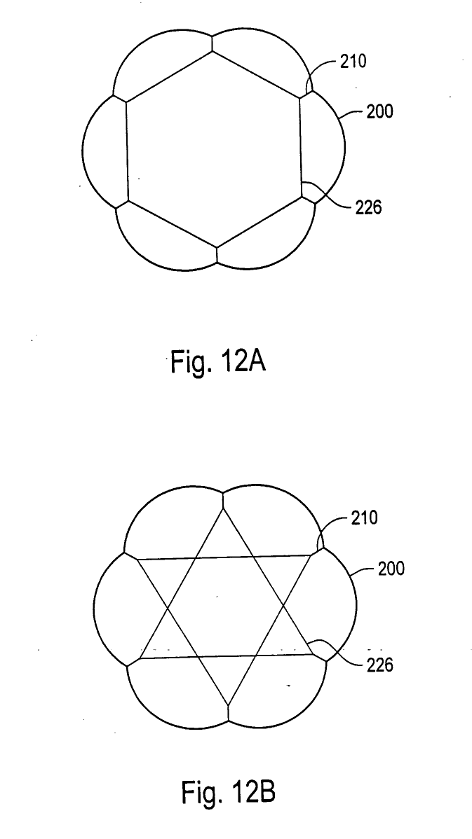

In another embodiment of the invention, a polygon-shaped internal lobe intersection curtain arrangement is used to produce the multi-lobed airship. FIGS. 12A and 12B illustrate two different embodiments of a six-lobed version of the multi-lobed airship. Hull 200 can be enlarged or reduced in size by pulling in the lobes. The lobes are partially formed by membranes, walls or curtains 210. The membranes, walls or curtains 210 are connected to load lines 226. Pulling in the lobes will reduce the volume of the airship, resulting in a decrease in airship altitude. The lobes can be pulled in so that the intersection of the walls or curtains of each lobe is almost coincident with the airship longitudinal axis.

The polygonal arrangement of load lines is not limited to a single continuous polygon, as shown in FIG. 12A, but may also include multiple overlapping polygons. For example, in a 6-lobed hull configuration, the load lines may form a single hexagon. The load line arrangement may also be configured as two overlapping triangles, as shown in FIG. 12B.

To reduce the amount of force needed to contract and expand the lobes, the expansion and contraction of the lobes may be done at night, when the lifting gas pressure of the airship is relatively low, at least to the value during daylight.

This process is reversible. If the lobes are already pulled in, letting out the lobes will increase the airship volume, which will result in an increase in airship altitude. This variation in airship volume could give an airship a pressure-altitude excursion range of P₁ to 2.5×P₁, such as, for example, from 70 to 28 millibars, or from 65,000 to 80,000 feet, a region of minimal stratospheric winds.

Advantages of this invention over airships which use ballonets pumped with air for achieving altitude changes are a saving in airship weight because the ballonets are heavier than the curtains of this invention, and a possible reduction in overall aerodynamic drag forces due to a changed cross-sectional area of the airship.

In this regard. Aerodynamic drag force magnitude is usually modeled as:
Drag=½*(Air Density)*Velocity²*(Drag Coefficient)*(Area Term)
where Area Term is either the cross-sectional area, surface area, or (Volume)^{2/3}, depending on how the Drag Coefficient was derived. In any event, a conventional airship does not change its area term when altitude is decreased, but an airship with “pulled-in” lobes will reduce its area term with respect to an airship with expanded lobes, and thus, the airship's aerodynamic drag can potentially be reduced when compared with a constant volume airship with ballonets.

Although not necessary to understand the disclosed invention, applicants present a theoretical basis to explain how lobes help reduce the physical stress on the hull. This theoretical basis is not presented as in any way defining or restricting the scope of the invention. It is presented merely as an aid to understanding the invention.

Consider the following membrane stress equation:

$$\frac{Δ P}{th} = \frac{σ c}{Rc} + \frac{σ a}{Ra} \qquad ( 1 )$$

(taken from Timoshenko, S. and Woinowsky-Krieger, S., Theory of Plates and Shells, 2nd Ed., pp. 356-359, New York, McGraw-Hill, 1959.)

The equation is derived from a balancing of the forces in the normal direction that are acting upon a differential area of the membrane, where:
ΔP is the pressure difference between the lifting gas and the atmosphere;
th is the hull material thickness;
σ_{c} is the hull stress in the circumferential direction;
σₐ is the hull stress in the longitudinal direction;
R_{c} is the hull radius of curvature in the circumferential direction; and
Rₐ is the hull radius of curvature in the longitudinal direction.

To illustrate how reducing the hull radius of curvature reduces the amount of stress on the hull, consider a long, pressurized cylindrical hull such as the prior art hull 12 shown in FIG. 1. The radius of curvature Ra of the hull 12 in the axial, or longitudinal, direction is essentially infinite because the surface of the hull 12 in this direction is virtually a straight line. Therefore, the

$$\frac{σ a}{Ra}$$

term of Equation (1) tends toward zero, meaning the longitudinal stress component contributes very little to reacting against the differential pressure on the hull 12, and may thus be ignored. Removing this term from Equation (1) and rearranging the remaining terms results in the following equation:

$$σ c = \frac{Δ P \cdot Rc}{th} \qquad ( 2 )$$

It can be seen from Equation (2) that the stress σc on such a hull is directly proportional to the radius of hull curvature Rc in the circumferential direction. Therefore, the smaller the circumferential radius of curvature of the hull, the smaller the amount of physical stress acting on the hull.

Referring again to FIG. 12, load lines 226 may be fastened to flexible membranes in any suitable number, and location(s) and may use grommets, tumbuckles, or any other suitable connection means, including direct or indirect bonding, or the load lines may be formed as a continuation of the flexible membrane material, for example.

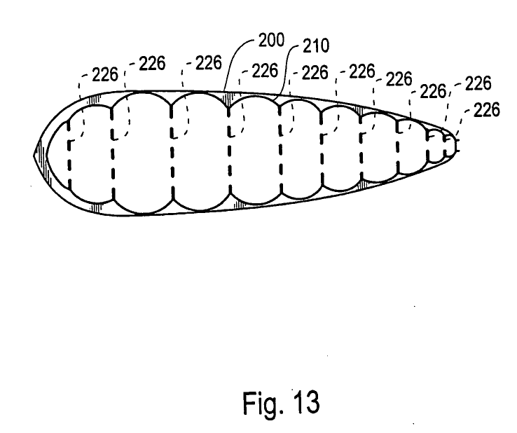

FIG. 13 illustrates the internal cross-section of an airship with multiple lobes.

For conventional non-lobed airships, the pressure induced circumferential loads are approximately twice as high as the pressure induced longitudinal loads. With the introduction of the circumferential stress lowering lobes, the longitudinal loads could now be many times larger than the lobed circumferential loads. By judiciously designing the curtains and their suspension lines to carry a portion of the longitudinal loads, the circumferential and longitudinal hull loads can be balanced to optimize the use of the hull material, resulting in the greatest weight savings.

Preliminary design trade studies indicate a tremendous savings can be realized with an airship using a multi-lobed hull, because of the compounding effect of the hull mass reduction. If the hull mass is reduced, a smaller airship volume is needed to carry the same payload at the same speed. If the airship volume is reduced, so is the aerodynamic drag, so less propulsion is required. Smaller motors are required, less propulsion power is required, etc., making the airship even smaller. Hull area reductions up to 85% are possible, so even if construction costs are increased, there are savings to be realized in the other airship systems such as power generation, power storage, propulsion, and the size of infrastructure needed to support the airship.

While this invention has been described in conjunction with various exemplary embodiments, it is to be understood that many alternatives, modifications and variations would be apparent to those skilled in the art. Accordingly, Applicants intend to embrace all such alternatives, modifications and variations that follow in the spirit and scope of this invention.

1. An airship, comprising:
a non-rigid or semi-rigid hull with a plurality of longitudinally extending lobes formed therein;
means for forming the plurality of longitudinally extending lobes in the non-rigid or semi-rigid hull;
a group of load lines connected to and running between the means for forming the plurality of longitudinally extending lobes, the load lines forming a polygon-shaped cross-sectional area,
wherein each of the longitudinally extending lobes have a smaller circumferential radius of curvature than a non-lobed hull of similar cross-sectional area.

2. The airship of claim 1, wherein the means for forming the plurality of longitudinally extending lobes includes membranes attached to an inner surface of the non-rigid or semi-rigid hull.

3. The airship of claim 2, wherein the membranes and the load lines carry at least a portion of a circumferential load and a longitudinal load of the non-rigid or semi-rigid hull.

4. The airship of claim 3, wherein the circumferential load and the longitudinal load on the hull are balanced.

5. The airship of claim 1, wherein the means for forming a plurality of longitudinally extending lobes includes a curtain attached to an inner surface of the non-rigid or semi-rigid hull and extending along a longitudinal direction of the non-rigid or semi-rigid hull.

6. The airship of claim 5, wherein the curtain has a suspension line attached thereto and a load line attached to the suspension line.

7. The airship of claim 6, wherein the curtain and the suspension line, carry at least a portion of a longitudinal load of the non-rigid or semi-rigid hull.

8. The airship of claim 1, wherein the group of load lines do not pass directly through or near a centralized volume of the airship.

9. The airship of claim 1, wherein the non-rigid or semi-rigid hull has a cross-sectional height substantially the same as its cross-sectional width.

10. The airship of claim 1, wherein the membranes attached to the inner surface of the non-rigid or semi-rigid hull extend along a longitudinal direction of the non-rigid or semi-rigid hull.

11. The airship of claim 1, wherein the polygon-shaped cross-sectional area forms a hexagon.

12. The airship of claim 1, further comprising a plurality of groups of load lines.

13. The airship of claim 1, wherein each group of load lines is located at a different location along the longitudinal axis of the airship.

14. The airship of claim 1, wherein the membranes comprise a mesh.

15. The airship of claim 1, wherein the edge of at least one of the membranes is facing the longitudinal axis of the airship and has a parabolic shape.

16. A method of increasing the lifting capacity of an airship having a non-rigid or semi-rigid hull by decreasing the mass of the non-rigid or semi-rigid hull, comprising:
attaching a load line to the inside of the non-rigid or semi-rigid hull;
decreasing the radius of curvature of the non-rigid or semi-rigid hull with the load line to form a plurality of extending lobes in the non-rigid or semi-rigid hull and to make a lobed non-rigid or semi-rigid hull having a cross-sectional height substantially the same as its cross-sectional width to permit a decreased non-rigid or semi-rigid hull mass;
wherein the load line forms a cross-section that is in the shape of a polygon.

17. The method of claim 16, wherein the load lines have a fixed, substantially non-extendible length.

18. The method of claim 16, further comprising:
reducing the longitudinal stress on the non-rigid or semi-rigid hull when decreasing the radius of curvature of the non-rigid or semi-rigid hull.

19. An airship, comprising:
a non-rigid or semi-rigid hull;
a plurality of extending lobes formed in the non-rigid or semi-rigid hull; and
a plurality of curtains attached to and extending completely between opposing inner surfaces of the non-rigid or semi-rigid hull and extending along a longitudinal direction of the non-rigid or semi-rigid hull.

20. The airship of claim 19, further comprising:
a plurality of load lines connected to the curtains; and
an opening down the center of the non-rigid or semi-rigid hull defined by the plurality of load lines.
